(19) United States
(12) Patent Application Publication
(10) Pub. No.: US 2025/0156819 A1
(43) Pub. Date: May 15, 2025

(54) METHODS OF QUALITY CONTROL TO VALIDATE CABLE LEAKAGE REPAIR AND WORKMANSHIP

(71) Applicant: ComSonics, Inc., Harrisonburg, VA (US)

(72) Inventors: Ken Couch, Harrisonburg, VA (US); Raymond Gregory Jones, Stephens City, VA (US); Austin Joachim, Harrisonburg, VA (US)

(21) Appl. No.: 18/925,179

(22) Filed: Oct. 24, 2024

Related U.S. Application Data
(60) Provisional application No. 63/598,599, filed on Nov. 14, 2023.

(51) Int. Cl. G06Q 10/20

(52) U.S. Cl. CPC G06Q 10/20

(57) ABSTRACT

Solutions are described for cable operators who desire to more closely manage their cable leakage maintenance and ensure their technicians are properly fixing leakage that has been assigned to them via work orders. Quality control leakage measurements are recorded after the completion of a work order to verify the leak has been repaired. Exemplary automated leakage measurement logic flows account for a variety of different technician behavior scenarios as well as real world limitations. The complex considerations ensure the correct QC measure is associated with the correct work order. In addition to making automated quality control measurements, the process is further enhanced by connecting to the operator's work order management database and adding the QC measurement data to the work order. This allows operators to use their own workforce management tools to monitor and track successful work order completion.

### CROSS-REFERENCE TO RELATED APPLICATIONS

This application claims the benefit of U.S. Provisional Patent App. No. 63/598,599, filed Nov. 14, 2023, the complete contents of which are herein incorporated by reference.

### FIELD OF THE INVENTION

Embodiments generally relate to managing cable TV leakage and, more specifically, addressing the need to validate that a technician has performed a proper repair of a cable TV leak.

### BACKGROUND

Since the beginning of cable TV infrastructure deployment, maintaining the network has always been a critical part of a successful business model. The network portion of the cable TV infrastructure is largely deployed outside, and thus, is constantly exposed to changing environmental conditions: heat, cold, wind, natural damage (such as falling trees, animal damage such as squirrel chews), and more. These environment conditions play a large part in causing the cable shielding integrity to significantly degrade in portions of the network where damage occurs. In turn, the degradation of the cable shielding integrity allows cable TV signals that are transmitted over the network to escape into the air which is commonly called cable leakage.

The FCC requires all cable operators to find and fix cable leakage, particularly if the leakage has an over-the-air signaling strength >17μ V/m in the FAA band of 118 MHz to 136 MHz. One of the primary job functions of a network maintenance technician is to repair the damaged sections of cable that are triggering leakage detection. The typical process to repair cable leakage is for the cable operator to assign work orders to maintenance technicians (“techs”). A typical work order contains information about a leak's general location, its frequency, and its general amplitude level. The technician's job is to track down the exact location of the leak, repair it, and then report back that the leak had been fixed.

Unfortunately, not all technicians accurately or honestly report back the leak status when closing out the related work orders. Sometimes, a technician will choose to report back that a leak has been repaired without fixing the leak. Sometimes a technician tries to repair a leak, does so unsuccessfully, but still reports that it was fixed. To date, cable operator management has no way to validate that the leak had actually been corrected. The status quo is largely a trust-based system. The industry has a long felt but unmet need for an alternative to relying on the information of whether or not a work order has been closed as the sole basis for determining whether a leak has in fact been satisfactorily fixed.

### SUMMARY

Some embodiments of the invention solve the problem of a technician's misreporting that a leakage was repaired when it actually was not repaired. Some embodiments of the invention require the technician take additional steps to provide a verification method that the leak has been properly fixed. Some embodiments of the invention automate the verification that a leak has been properly fixed without any interaction or reporting from the technician. This in turn starts to correct the behavior of technicians by making them accountable for their inaction.

A significant feature of exemplary embodiments entails deriving additional utility from existing leakage detection equipment. Existing leakage detection equipment is generally configured, as the name implies, to detect leaks. This is to say, in general, conventional existing leakage detection equipment and methods of its use are solely preoccupied with finding leaks and place no significance on detecting or determining the counterfactual: an absence of a leak. In addition, conventional leakage detection equipment does not have a communication connection to the cable operator's WO management system in order to exchange information on a real time basis. In such circumstances, no information can be exchanged between the two platforms at the time of leakage detection without some sort of manual intervention. Unique to some exemplary embodiments herein are additional hardware configurations and information processing steps which leverage use of the same equipment conventionally used for finding new leaks in a network for the additional functionality of identifying repaired leaks/validating repair of an “old” leak (which is to say, a leak detected sometime in the past and therefore already known to the service provider). Exemplary systems and methods may comprise the collection of signal measurements which may be characterized as quality control (QC) measurements.

Some embodiments are a solution to a problem which may be characterized as follows. During a single day, a fleet of repair technician vehicles and the technicians driving them may collect many hundreds or thousands of QC measurements. To ascertain whether a single particular leak has been fixed, a solution is needed which can systematically select (through manual and/or automated steps) one QC measurement from among the hundreds or thousands of measurements which are available to choose from. The one QC measurement selected must, within a high level of confidence, contain information that empirically demonstrates the particular leak in question has been fixed or has not been fixed.

According to an aspect of some embodiments, at least some of a plurality of QC measurements are automatically collected by sensors. Exemplary sensors for the automatic collection are vehicle-based leakage detectors. Handheld leakage detectors are another data collection device which may be responsible for some QC measurements that are taken. The total available QC measurements from among which a particular QC measure is identified/selected to match to a closed WO may include some QC measurements which were not collected automatically. Some of the available QC measurements may have been collected in response to a manual triggering of a sensor by a technician.

Exemplary embodiments deliberately minimize human (in particular, technician) input or decision making. Embodiments may deliberately exclude some or all technician input or capability to manipulate data which is collected and relied upon to ascertain whether or not a leak has been repaired. One exception for some exemplary embodiments is an input from a technician which changes a work order (WO) status from open (incomplete) to closed (complete), or some similar status change to a WO or comparable data element (e.g., data structure or document) which describes a leak in a non-transitory format.

An exemplary process to determine if a leak that is associated with a particular work order has been repaired is fairly complex when taking into account many different variables. The following exemplary method may serve as a high level structure into which exemplary data processing subroutines may be incorporated for some embodiments:
Step 1: Technician gets Work Order which has the GPS location and information about the leak they must repair.
Step 2: Technician travels to the leak location with instruction to park his vehicle within a specified distance from the leak. For example, typically within 500 feet and not further than 1,000 feet.
Step 3: Technician fixes the leak. The vehicle must be parked for some minimal amount of time while fixing the leak, for example, 10 mins. Once the leak is repaired, the technician can close the work order indicating the leak has been fixed. This information is sent back to the Work Order server.
Step 4: Technician retrieves his next work order from the Work Order server. Then the technician drives off to his next assignment. An additional requirement for the technician to leave the site after closing the work order in a maximum amount of time can also be required. For example, the technician must leave for his next assignment within 15 mins of closing the current work order.
Step 5: At the moment the technician leaves for his next job, the leakage detector in his vehicle is programmed to automatically take a leakage measurement that is labeled as a Quality Control (QC) measurement. The GPS location and time of day is also captured. An alternative approach is for the technician to manually take an action to force a QC measurement.
Step 6: The QC measurement, GPS, time information, and leakage detection device ID is sent to the remote server. At the server, the leakage detection device is linked to the technician's name and assigned vehicle.
Step 7: The remote server gets all closed work order information from the cable operator's work order server. Closed work orders have associated identifiers such as the technician's name who closed the work order and their associated vehicle ID. The location of all leaks in the closed work orders are collected and then compared to the location of the vehicles when they took a QC measurement. If the location of a leak and the location of the vehicle that took a QC measurement are within distance limit (e.g., 500 feet) of each other and the vehicle ID matches the vehicle ID assigned to the closing technicians, then the corresponding QC measurement will be associated with the closed work order.
Step 8: The QC measurement for the matching leak location is then attached to the closed work order as a form of verification. If the QC measurement still has a leak present, the QC measurement will indicate a failure status on the work order.
   The eight basic steps outlined above do not explicitly account for a range of variables and real world situations that require additional logic. Various embodiments and features of this disclosure expound on various processes and subprocesses which account for such variety of real world situations.

Embodiments of this disclosure are solutions for cable operators who desire to more closely manage their cable leakage maintenance and ensure their technicians are properly fixing leakage that has been assigned to them via work orders. Some exemplary methods herein automatically take a quality control leakage measurement after the completion of a work order to verify the leak has been repaired. In addition, some exemplary embodiments provide a range of parameters that allow cable operators to customize the automated process that better matches their management preferences. The customizable parameters include aspects such as but not limited to:
The distance from the leak to the technician's parked vehicle to be in range to make a valid leakage measurement.
How much time does the technician have between closing a work order and moving on to the next job
The maximum leak level allowable after a repair
Preferred and Maximum values to allow for flexibility with limits
   Exemplary automated leakage measurement logic flows account for a variety of different technician behavior scenarios as well as real world limitations. The complex considerations ensure the correct QC measure is associated with the correct work order. In addition to making automated quality control measurements, the process is further enhanced by connecting to the operator's work order management database and adding the QC measurement data to the work order. This allows operators to use their own workforce management tools to monitor and track successful work order completion.

### BRIEF DESCRIPTION OF THE DRAWINGS

FIG. 1 is a diagram representing some exemplary hardware and functionalities involved in exemplary systems and methods for automated quality control to validate that cable TV leaks have been properly repaired.

FIG. 2A is a process of existing cable leakage repair practices which resemble an honor system dependent on information manually submitted by techs.

FIG. 2B is an exemplary process for cable leakage repair and validation.

FIG. 3A is a diagram illustrating a scenario in which a tech closes a work order then departs from the jobsite.

FIG. 3B is a diagram illustrating an alternative scenario in which a tech neglects to close a WO before departing from the jobsite but still closes the WO at a later time.

FIG. 4 illustrates an exemplary process usable for the identification of one QC measurement from among a pool of many for use in validation.

FIG. 5 is a diagram illustrating possible relationships of QC measurements to a particular leak location and WO closure time.

FIG. 6A is a process of cable leakage repair which is a manual system dependent on information that connects the WO to the QC measurement to be manually submitted by techs.

FIG. 6B is a process of cable leakage repair which is an automated system that is not dependent on techs to enter any data that connects the WO and QC measurement.

FIG. 7A is a non-limiting example process for how a QC measurement may be identified from among many QC measurements for association with a closed WO when leakage detection device ID is known.

FIG. 7B is a non-limiting example process for how a QC measurement may be identified from among many QC measurements for association with a closed WO when leakage detection device ID is not known.

### DETAILED DESCRIPTION

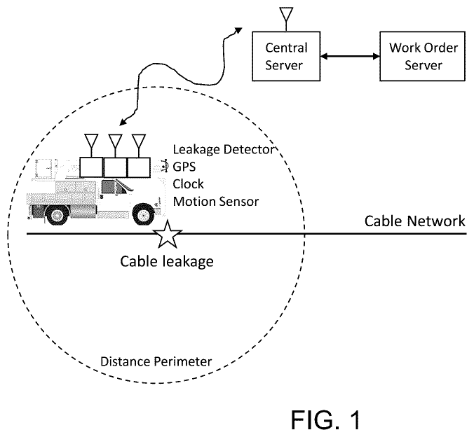

Exemplary systems for manually assisted and/or automated quality control to validate that cable TV leaks have been properly repaired involve both hardware and software components. FIG. 1 provides a visual summary of components involved in an exemplary system. A vehicle-based leakage detector collects information which characterizes the actual real-world state of the cable network. Exemplary systems generally include a great many vehicle-based leakage detectors and may also include leakage detectors which are handheld and thus portable beyond the vehicles.

Leakage detectors are responsible for collecting information about leakage in the cable network. In exemplary systems described herein, leakage detectors are configured for collection of quality control (QC) measurements. QC measurements may be distinguished from leakage/leak measurements insofar that collecting QC data may entail, in the extreme case, not detecting an over-the-air signal. A QC measurement recording a leakage signal level of “0” or near zero is generally still desirous to record and use in subsequent determinations. By contrast, a detector (and supporting electronics) configured only for leakage detection may be expected to make no particular electronic record which reflects “looking for” a signal at some location and at some frequency (or in some frequency band) and finding a zero or insubstantial signal level. Leakage measurements may be employed in some exemplary processes for quality control purposes, making them qualify as both “leakage measurements” and “QC measurements”. However, the opposite is not always true. Many “QC measurements” may be expected to reflect the absence of a leak in the cable network at a particular location and at one or more frequencies. Accordingly, it may be inaccurate for such QC measurements to be characterized as “leakage measurements”.

In general, when this disclosure refers to “leak” or “leakage”, those of ordinary skill in the art will recognize a written record of the leak/leakage may be implied based on the context of use. It is generally implied that a record is created or already exists of the incident, typically an electronic record in an electronic storage medium.

Continuing the description of FIG. 1, an exemplary leakage detector, especially vehicle-based leakage detectors such as those already in use in the industry at the time of this disclosure, incorporate, are accompanied by, or are otherwise closely associated with, a location module (e.g., with GPS location capability), a motion sensor (such as an accelerometer), an accurate clock (for keeping time, typically measured according to a conventional 24 hour day, i.e., time of day), means to transmit collected leakage and vehicle information to a remote server (typically wireless, e.g., a wireless data connection module), and means for bi-directional access to retrieve and add new data to existing work orders.

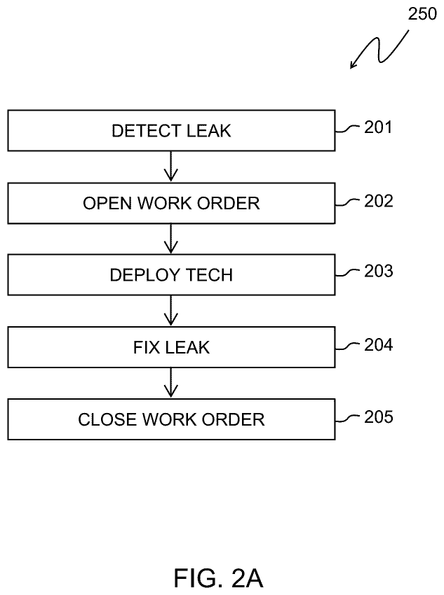

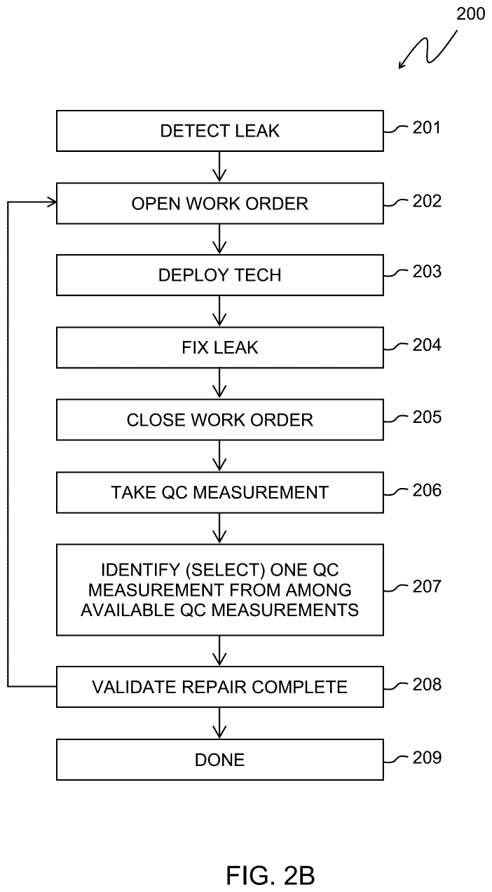

FIG. 2A presents a process 250 summarizing existing cable leakage repair practices. Leakage detectors, typically vehicle-based leakage detectors, detect leaks at block 201. A fleet of vehicles may contribute to this collection, monitoring the cable network as the vehicles travel around a geographic area. Vehicles may be driven around expressly for the purpose of detecting leaks. In addition, or in the alternative, leakage detection (block 201) may be performed by vehicles while they are also in use for some other purpose. For instance, a tech may drive a vehicle to a jobsite for a particular job. (As used herein, “jobsite” refers to a location where some job is to be performed and is not necessarily related to construction.) The vehicle-based leakage detector may detect leaks en route to and from the job site. The particular job at the jobsite may be entirely unrelated to leaks which are detected en route to or from the jobsite.

Leaks detected at block 201 generally require repair. For a leak to be repaired, a work order is opened (e.g., created) at block 202. It will be understood that “work order” is used for consistency with prevailing industry terminology at the time of writing this disclosure, but “work order” and its abbreviation “WO” may be understood to refer to any record which signifies (specifies) one or more tasks related to a problem. In exemplary embodiments, the problem is a network leak, and the task is repairing the cable infrastructure to eliminate the leak (i.e., repairing/fixing the leak). An “open” work order refers to a record of at least one task not yet completed and which future completion remains desired. A “closed” work order refers to a record of at least one task which is completed or which is no longer considered necessary or desired (and therefore though perhaps the task was never completed, future completion is no longer desired, e.g., because of a decision to not expend resources that would be required for the completion).

In the cable network industry, a person responsible for carrying out the task of fixing a leak is typically referred to as a technician or “tech”. It will be understood that use of “technician” or “tech” in this disclosure generally refers to an entity (e.g., a person) assigned to carry out the task(s) recorded in a given work order. Generally, “assigning” a task implies one or more records being updated to document the assignment in a non-transitory medium. In the context of the summary offered by process 250 of FIG. 2A, assignment of a tech to a WO may occur at block 202 or as part of block 203. In either case, at block 203, the assigned tech is sent/deployed to carry out the task of fixing the leak block 203. Block 203 includes the physical, real world activity of the tech setting out and traveling to the location indicated by the WO as the location where the recorded leak exists and requires repair. Once at the location/site of the leak, the tech fixes the leak (i.e., makes the repair) at block 204. After the repair is completed, meaning the task documented by the work order has been completed, the work order status is changed from “open” to “closed” at block 205. In general, the tech assigned to the WO manually makes this change in the record.

FIG. 2B shows an exemplary process 200 which incorporates but augments and improves the process 250 from FIG. 2A. Upon or after the WO being closed at block 205, a QC measurement is recorded at block 206. The QC measurement can be taken either through a manual action of the technician or it can be taken automatically. The recorded QC measurement may include a plurality of variables such as one or more (up to all) of the exemplary QC measurement variables listed in Table I below. The QC measurement and the plurality of its variables are stored in a database along with all other QC measurements collected over a specified period of time. At block 207, one (a single) QC measurement is identified (selected) from among many available QC measurements. The identified/selected QC measurement is associated with the WO which was closed at block 205. At block 208, the completion of the repair is validated. In particular, signal information of the leak for which the WO was opened is compared with the signal information of the QC measurement selected at block 207. The comparison reveals whether or not the leak was fixed according to data from actual signal measurement equipment (as opposed to relying on the qualitive word of a technician). If the validation passes, the process is finished (block 209). However, if the validation fails, further action (one or more corrective actions) is initiated. For instance, the work order at issue may be reopened.

The collection of QC measurements is itself a unique feature of embodiments of this disclosure, not to mention exemplary processes for such collection. As already discussed above, QC measurements are in some respects related to and yet are distinguishable from leakage measurements. For an exemplary fully automated QC measurement process, detection equipment of tech vehicles may be configured to take QC measurements every time the vehicle stops for a specified period of time, 10 mins for example, and then starts to move again. The specified period of time may be referred to as a stationary time trigger. This automated triggering of data collection based solely on the activity of the vehicle eliminates the need for the technician to take any direct action in order to get a QC measurement. All that is required is that a tech's vehicle remains stationary for the minimum time threshold, such as but not limited to 10 mins, which typically happens when a tech parks his or her vehicle in order to fix a leak.

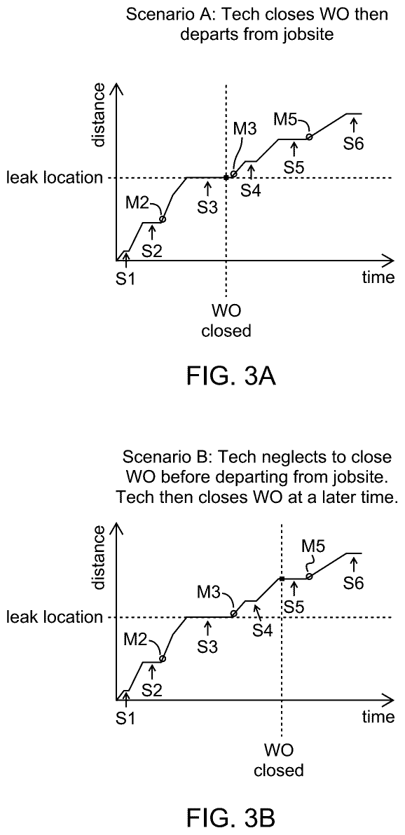

FIGS. 3A and 3B provide simplified illustrations of automatic QC measurement collection. The line in each of the figures represents the travel of a tech vehicle from some fixed reference location, such as a company depot. Each plateau in the line represents the tech vehicle stopping for some duration of time. The circles M2, M3, and M5 mark the time/location information when an automated QC measurement is taken and recorded. Stops S2, S3, and S5 are of sufficient duration to meet or exceed the stationary time trigger limit to automatically trigger a QC measurement M2, M3, or M5 to be recorded. By contrast, stops S1, S4, and S5 are of insufficient duration to trigger an automated QC measurement to be recorded. Generally, it is advantageous for the value of the stationary time trigger limit value to be chosen so that relatively short vehicular stops such as those which correspond with braking at a traffic light or stop sign fall short of the stationary time trigger limit while typical durations required to complete network repairs exceed the value of the limit.

Though FIGS. 3A and 3B show the recorded QC measurements M2, M3, and M5 (the circles) occurring just as the vehicle begins to move after a stop of sufficient duration, embodiments may instead record QC measurements shortly before the vehicle begins to move away. To achieve the latter configuration, the leakage detection/QC measurement equipment may be configured to continuously monitor leakage levels and temporarily store detected values in an analog or digital cache memory (short term memory). The memory may only keep values extending in the past some short duration, such as thirty seconds or a minute. The values in the cache are continuously replaced with newer values as time progresses. When vehicle movement is detected, however, a value in the cache corresponding to a time from a short duration prior to the start of the movement is recorded in a long term memory storage.

FIG. 3A and FIG. 3B differ according to the timing of when the tech closes the work order corresponding to a leak he was deployed to fix at the distance indicated by “leak location”. In Scenario A, depicted by FIG. 3A, the tech makes the repair at stop S3, closes the WO, then departs stop S3 to head to the next jobsite. This is an exemplary sequence of events to which techs may be expected to adhere. However, human error is inevitable. In Scenario B, depicted by FIG. 3B, the tech makes the repair at stop S3 but neglects to close the WO before departing the stop S3 jobsite. The tech eventually remembers the omission and closes the WO at stop S5.

The automated QC measurement recording method described in the preceding paragraphs adds complexity to the resulting data set of QC measurements. One issue is that some of the automated QC measurements are likely to be entirely irrelevant to any WOs. The tech vehicle may be expected to stop for more than the stationary time trigger limit (e.g., 10 mins) for a variety of reasons other than for making a leak repair over the course of the day, and such stops will nevertheless result in an automatically recorded QC measurement. Each tech vehicle will collect QC measurements over the course of a specified period of time (e.g., 24 hours) which are stored in a common database. Each tech vehicle may produce a QC measurement when the respective tech takes a lunch break, for example. A QC measurement will be taken each time the truck is stationary for more than the time limit (e.g., 10 minutes) regardless of whether or not the tech is working on repairing a leak. As a result, exemplary methods of QC measurement collection include post processing of the collected data set to determine which QC measurement is the actual measurement to be associated with a WO closure and not some random non-work order related stop (gas station, lunch, etc.).

The contrast of FIGS. 3A and 3B illustrates a second complication of automated recording of QC measurements. For any particular leak, the closure time of that leak's WO may come before or may come after the QC measure time of the single QC measurement which provides the best (and often the only) objective evidence capable of validating the leak was successfully repaired. In other words, the time delta of (QC measure time-WO closure time) may be positive or negative, and the magnitude of the time delta is also subject to variation from one WO to the next. Generally, as Scenario B of FIG. 3B illustrates, WO closure location cannot be expected to necessarily correspond with leak location, and many exemplary embodiments of this disclosure do not rely upon or even record a WO closure location. Exemplary methods of this disclosure anticipate and account for possibilities like Scenario B. Thus, regardless of whether a particular WO happens to be handled according to Scenario A or Scenario B or some other scenario, exemplary methods of this disclosure are still able to pair an appropriate QC measurement with a given WO for purposes of validating networks repairs and tech workmanship.

Cable network maintenance and repair is a never-ending process. From a business perspective, new leaks will inevitably occur into the foreseeable future. Accordingly, new WOs will inevitably be created, assigned, and eventually closed. Relatedly, the need and utility of collecting and using new QC measurements will remain into the foreseeable future. It therefore becomes useful for some exemplary processes to set general conditions for determining a finite subset of QC measurements which may be considered as candidate data for validating a finite subset of WO closures. Time of WO closure and time of QC measurement collection are exemplary variables which may be used for this purpose. To illustrate, it may be generally said that a QC measurement taken in June 2024 can be safely ruled out as being helpful for validating a WO which was closed in April 2024 or earlier. Similarly, it would prove unhelpful to attempt validating a WO closure in June 2024 using a QC measurement collected in April 2024. In general, when considering any particular WO order closure, the advantages of present embodiments can be realized from consideration of just those QC measurements collected within a few days, preferably within a day, of the WO being closed. To this end, according to some exemplary embodiments, QC measurement data and WO data is collected by a remote server over a full 24 hours to account for all possible work shifts. A time delay may be imposed at the remote server in post processing after the work order was closed (for example 5 hours) to ensure all relevant QC measurement data has been received at the remote server in cases of poor internet coverage or unexpected device shutoff. An ongoing scheduled process (for example, every 5 minutes) checks for any unprocessed work orders not yet subjected to validation but which have resided as closed on the server for more than the imposed delay and then proceeds to process them through validation using QC measurements collected in the same 24 hour period. WO closures and QC measurements which fall into the preceding or succeeding 24 hour period are not compared with WOs or QC measurements of the instant 24 hour period at issue. If desired, some embodiments may use time periods other than 24 hours as the basis for creating WO and QC measurement data “batches”/sets to be used together. For instance, data batches of WOs and QC measurements may be based on 12 or 48 hour periods if desired, or some other length of time.

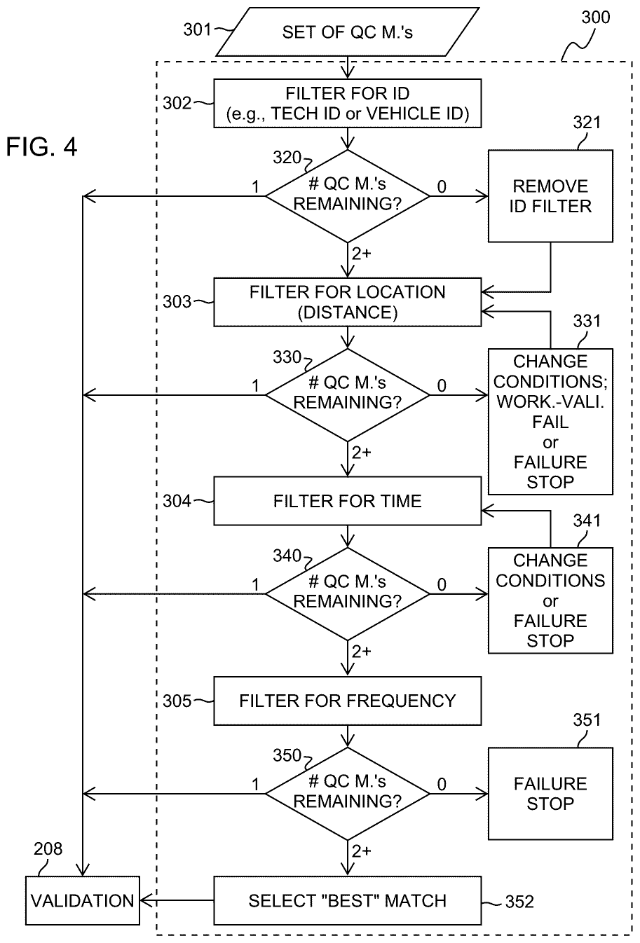

FIG. 4 illustrates an exemplary process 300 usable for the identification of one QC measurement at block 207 of FIG. 2B. A single closed WO is applied to process 300 to find a matching QC measurement. The general purpose of process 300 is to narrow down many possible/available QC measurements 301, ideally to a single QC measurement which can then be compared against the leak information for a particular leak with which the particular WO is concerned. The process 300 may be used in connection with each WO of many WOs. The process 300 is advantageous for efficiently sorting and filtering what in practice can be many thousands of QC measurements. The sequence of criteria depicted by FIG. 4 is exemplary for achieving efficiency, with prioritization given to applying criteria/filters which are, as a general matter, expected to narrow the list of QC measurements by the greatest degree over the criteria/filters which are, again as a general matter, expected to be less effective at eliminating a substantial a number of QC measurements from consideration. It should be appreciated, however, that logic flows besides that which is portrayed by FIG. 4 may be used in the practice of the invention. Some applications of the technology described by this disclosure may be facilitated by different sequencing of filters, for instance, or by the concurrent application of multiple filters.

The process 300 makes use of data/variables summarized by Tables I, II, and III. In general, the individual datum elements may be characterized as identification (ID) information, location information (which includes distance), time information, and signal information (which includes frequency and amplitude information). Table I is primary data, which is to say data which tends to be directly measured (e.g., time of day, GPS coordinates, signal frequency and strength) or else which is a type of innate identification (IDs) used to name individual entities (be that entity a person, vehicle, or WO, for example). By contrast, Table II is secondary data, which is to say variables which are determined by particular combinations of primary data. Distance is a difference between two locations. Time delta is a difference between two (clock) times. Table III contains various limits/thresholds/bounds. For exemplary illustration, most embodiments in this disclosure employ pairs of thresholds. A tighter/narrower limit or threshold is referred to as “preferred”, whereas a looser/broader limit or threshold is referred to as a “maximum”. In the practice of the invention, a single limit or threshold may be used or else more than two limits/thresholds may be used for the same variable, depending on the needs of a particular user of the invention. Again, for illustrative purposes, two limits/thresholds tend to be used for the illustrative embodiments like process 300 of FIG. 4 for each of several types of information (in particular location information and time information).

TABLE I
primary data for decision making logic

| | leakage | work order | |
|---|---|---|---|
| | (measurement) | (WO) | QC measurement |
| data type | variables | variables | variables |
| ID information | | WO number | |
| ID information | | technician | |
| | | name/ID | |
| time | | WO closure | QC measure time |
| information | | time | |
| signal | leak | | QC measure |
| information | frequency(ies) | | frequency(ies) |
| signal | leak level(s) | | QC measure level(s) |
| information | | | |
| location | leak location | | QC measure location |
| information | | | |
| ID information | leakage | | QC measure device |
| | detection | | ID |
| | device ID | | |
| ID information | | | QC measure vehicle |
| | | | ID |

TABLE II
secondary data for decision making logic

| data | | | |
|---|---|---|---|
| type | term | calculation | description |
| location | distance | \|QC measure location − | the distance between a QC |
| infor- | | leak location\| | measure location and a leak |
| mation | | | location |
| time | time | QC measure time − | the time elapsed from WO |
| infor- | delta | WO closure time | closure to QC |
| mation | | | measurement; a positive (+) |
| | | | time delta means the WO |
| | | | closure precedes the QC |
| | | | measurement; a negative |
| | | | (−) time delta means |
| | | | the QC measurement |
| | | | precedes the WO closure |

TABLE III
limits/thresholds/bounds for decision making logic

| data type | term | description |
|---|---|---|
| location | preferred | Preferred distance from leak location that |
| information | distance | truck must park within when fixing the leak |
| location | maximum | Maximum distance from leak location that |
| information | distance | truck may park when fixing the leak |
| time | preferred | Preferred Time delta from WO closure to QC |
| information | time delta | measurement |
| time | maximum | Maximum Time delta from WO closure to QC |
| information | time delta | measurement |
| time | stationary | Time Period when a truck is not moving to |
| information | time | force a QC measurement when truck starts to |
| | trigger | move |
| | limit | |
| signal | maximum | Maximum Leak level allowed for a pass taken |
| information | leak level | by QC measurement |

Process 300 is explained first at a high level. The highest level blocks are blocks 302, 303, 304, and 305. These four blocks reflect four exemplary categories of variables for QC measurement identification. Block 302 is filtering based on ID information, typically leakage device ID (see Table I). Block 303 is filtering for location (e.g., distance) information (see Tables I, II, and III). Block 304 is filtering for time information (see Tables I, II, and III). Block 305 is filtering for signal information, typically frequency (see Table I). Each of the blocks 302, 303, 304, and 305 takes as input a list of multiple QC measurements and has, in general, three possible outputs. The three possible outputs are no QC measurements, one QC measurement, or a plurality/multiple QC measurements. As mentioned above, the primary goal of process 300 is to narrow down an initial data set of many QC measurements 301 to fewer, and ideally just one, QC measurement. If any of the blocks 302, 303, 304, and 305 yields a single QC measurement, remaining blocks which have not yet been performed may be skipped. Conversely, if any of the blocks 302, 303, 304, and 305 yields no QC measurements, the process 300 may either proceed as if the block's action had never been taken (the use of the particular filter is negated) or else the block's action may be performed again after adjustments are made to filter parameters (generally, this involves examining the same data type, but changing to a different limit/threshold/bound, see Table III). The latter scenario creates small return loops visible in FIG. 4. For many WOs, likely most WOs, process 300 yields a single QC measurement which can then be used for the next process, namely validation (block 208).

Process 300 may be employed for one or more further functionalities/benefits which are secondary to identifying a single QC measurement for subsequent validation of whether or not a repair was successfully completed so that a particular leak no longer exists. In general, “validation” can have either of two meanings in this disclosure. A first type of validation may be referred to as a “repair validation”. This first type of validation is entirely concerned with the state/integrity of the cable network and assists in ensuring that no matter the personnel attending to maintenance of the cable network, leaks which arise in the cable network and are detected are in fact getting repaired so the network continues to operate as expected and required by regulators. A second type of validation may be referred to as a “personnel validation” or “workmanship validation”. This second type of validation concerns whether or not a particular tech is doing his or her job in accordance with standard procedures. In some cases, the workmanship validation may serve as data which helps with personnel/HR decisions by the network operator and/or employer of a tech and as a means for a tech to be rewarded for doing his or her job well or else as a means for understanding in what ways a tech may improve in the satisfaction/performance of job expectations. The workmanship validation type may not necessarily convey whether or not a particular leak has or has not in fact been repaired.

For the “repair” validation type, a positive validation (which may also be referred to as a “pass” or “validated” status for example) may signify a known leak as having been repaired successfully. There is literally no longer a particular leak in the cable network, and such circumstance is known from more than the mere word of a tech. A negative validation (which may also be referred as a “fail” status for example) may signify a known leak as not having been repaired successfully, and thus the physical cable hardware of the cable network requires further physical attention.

For a “personnel”/“workmanship” validation type, “validation” may be used to describe whether or not a tech performed a repair and closed the associated WO in full accordance with procedural demands intended to standardize the repair and reporting process of techs generally. A network leak might be literally, physically repaired, yet a WO order closure may be assigned a “fail” validation status because the tech responsible for the WO failed to follow requisite standardized procedures. For instance, failure to timely report a WO closure, or failure to submit a WO closure at a location which is within a maximum distance from the leak location, might result in a failed validation. In general, the two types of validation closely correspond. That is to say, a “failed” validation most often means the leak still in fact exists, and the tech did not fully comply with standardized procedure. Conversely, a “passed” validation most often means the leak no longer exists, and the tech did fully comply with standardized procedure.

For purposes of explaining process 300 as an exemplary embodiment, it may be generally assumed that absent contrary explanation, the process 300 is at least always concerned with narrowing down the data set of many QC measurements 301 to one QC measurement which is usable for making the first type of validation (repair validation), which is to say, usable for confirming whether or not a leak specified by a given WO is, or is not, satisfactory repaired. This being said, process 300 is configured with the flexibility of providing multiple outputs, in particular, both a QC measurement by which the first type of validation may be performed (the leak was or wasn't repaired successfully) as well as a validation of whether or not the tech responsible for the WO did or not did fully comply with standardized procedure. These various alternatives will be made clearer by the following more specific examples and explanations.

A preliminary step to process 300 is to access or obtain the set of QC measurements (QC M.'s) 301 with which process 300 will begin. As an exemplary option, the data set 301 may be determined as all the QC measurements acquired over a particular period of time, e.g., a 24 hour period. The process 300 may then be performed for all of the closed WOs that have not been processed for QC measurements but have a closure time more than the prescribed time delay. The closed work orders will contain key information needed for the logic process, for example: the tech name who closed the work order, the time the WO was closed, and the associated leakage information such as the location, level, and frequency. See Table I, in which it should be understood that a WO record may include not only one or more (e.g., all) variables from the WO variables column but also one or more (e.g., all) variables from the leakage (measurement) variables column.

Block 302 is to filter the dataset 301 using identification (ID) information. In order to narrow down the possible QC measures collected by many vehicles over the course of a day, the tech's name may be used to reference the leakage detection device ID located in their vehicles. This assumes that the device ID has been assigned to a technician which is stored in the remote server database. If no device ID is associated with the tech, the number of QC measurements remaining (block 320) from block 302 would be zero (or null, which for purposes of this example may be treated interchangeably). In such case, the ID filter may be omitted entirely (block 321), and the process 300 may be proceed using alternative filters. However, in such case as sequential application of filters is desired, it is advantageous to begin with block 302 because it generally has the greatest elimination potential. In other words, narrowing down the QC measurements 301 according to their associations with respective single leakage detection devices greatly reduces the pool of QC measurement candidates.

Once the QC list 301 has been paired down to a single leakage detection device (if applicable), a location/distance filter may be applied at block 303. The leak location provided by the WO is used to find which of the QC measurements was taken at the closest distance to the leak. The list can be further narrowed by eliminating any QC measures that have a distance to the leak location that is greater than a primary filter constraint, e.g., a preferred distance limit or maximum distance limit. If no QC measurements are found using the primary filter constraint, the filter value may be changed at block 331 in an attempt to find a QC measure even though it is beyond the primary filter value. For example, the filter value for the distance my change at block 331 from 1,000 feet to 10,000 feet to determine if any QC measurements exist up to 10,000 feet by reprocessing this new filter value at blocks 303 and 330. This secondary filter value can be used to find a QC measurement that is appropriate to apply to the WO even though the distance is beyond a passing level determined by the primary filter value. At block 331, the WO may be marked with a work validation (“work.-vali.”) fail status, though the process 300 may continue through to validation block 208 where the repair validation may still receive a pass status. A sample scenario which may give rise to a WO which receives a workmanship validation fail but repair validation pass is the following: a tech successfully repairs the leak documented by the WO, an automated QC measurement gives empirical evidence of the repair being made successfully, but the tech forgets to manually close the WO until some time after he's left the leak location. Process 300 is designed to still be able to identify the appropriate QC measurement to pair with the WO for repair validation block 208 despite the tech failing to comply with all mandated procedures, in this instance the procedural rule that he close the WO before leaving the leak location.

If changing distance filter conditions at block 331 to a maximum distance limit still results in no QC measurements, the process 300 is stopped with a fail status for the repair validation. The remainder of process 300 needn't be performed, and the records are updated to reflect that no QC measurement was found which could be paired with the WO. On the other hand, if two or more QC measurements are found using either the primary or secondary filter at block 303, these multiple candidate QC measurements are passed to the next filter block 304.

Block 304 introduces a further useful criteria that must be met: the time between the WO closure and the QC measurement. The time filter may require that to pass, a QC measurement's time delta must be less than a defined time limit, for example +/−15 mins. The limit (i.e., cutoff) used for block 304 may be referred to as the preferred time delta. If two or more QC measurements are found that satisfy the preferred time delta constraint, they are passed to the next filter at block 305. If no QC measurements are found to satisfy the preferred time delta, the process 300 may perform a secondary filter operation for time (i.e., repeat block 304) after changing the time filter parameter(s) at block 341. Generally this entails making the limit against which each QC's time delta less restrictive. For example, the limit may be changed from the preferred time delta to a maximum time delta. As a non-limiting numerical example, the time limit may be expanded to not eliminate QC measurements which fall within the last 24 hours, thus the filter cutoff values would change from +/−15 mins to +15 mins, −24 hours. The process at blocks 304 and 340 would be reapplied to maintain in the list of candidate QC measurements those QC measurements which satisfy the new filter criteria. If no QC measurements are found after using a wider secondary filter set by block 341, the process 300 is stopped with a failed status for one or both of repair validation and workmanship validation. An abort operation at block 341 returns a final determination that a QC measurement was not found which could be paired to the WO for which process 300 was being performed. On the other hand, if two or more QC measurements are found by the time filter block 304 using either the primary or secondary time limits, they are passed to the next filter block at 305.

If desired, no secondary filter conditions may be applied, meaning that if no QC measurements are found by any of primary filter criteria at blocks 303/330, 304/340, or 305/350, the entire process 300 may terminate respectively at block 331, 341, or 351 with a “failure stop” condition. A “failure stop” in this context means the process 300 is stopped, repair validation fails, and workmanship validation fails.

Block 305 introduces a further useful criteria for narrowing the list of candidate QC measurements: a filter for frequency. To pass the frequency filter of block 305, the QC measure frequency of a QC measurement must match the leak frequency associated with the WO. Leaks can be detected at certain frequencies and not at others. The frequency filter 305 ensures the QC measure frequency matches the leak frequency listed on the WO. For example, the WO may list the leak frequency to be 138 MHz. The QC measurements which remain (which is to say are not eliminated) after frequency filter 305 will be only a subset of the original set 301 which have leak frequency of 138 MHz. Unlike the previous filter steps in the process 300, the frequency filter 305 process does not have a secondary filter step. A QC measurement's frequency must match the leak frequency specified in order to qualify as a valid QC measurement for use in validation of the WO. If no QC measurements of the original set 301 remain after applying the frequency filter 305, the process 300 is stopped at block 351 with a failed status for validation. No QC measurement was found, so the repair cannot be validated. On the other hand, if two or more QC measurements remain after frequency filter 305, a final single QC measurement from among the remaining candidate QC measurements will be selected that best matches the WO at block 352. Different embodiments may employ different subprocesses for the “best” match selection of block 352. As one option, the QC measurement with the smallest distance to the WO's leak location (see Table II) is used for the final selection criteria of block 352. Other criteria such selecting the QC measurement with the smallest time delta (see Table II) could be used instead or in addition to the smallest distance criterion.

After the set 301 of QC measurements has been reduced/refined to a single QC measurement (which as FIG. 4 shows may occur at any of multiple stages of process 300) the WO at issue is ready for validation at block 208. The act of identifying/selecting one QC measurement from among available QC measurements (block 207/process 300) does not in and of itself result in a passing validation. At block 208, the QC measure level must have less than the maximum leak level allowed. This level limit may be set to a different value according to any given embodiment. In the United States, the level limit is typically 17 uV/m, meaning a QC measurement validates a WO's repair as being completed at block 208 only if the QC measure level is <17 uV/m. The value of the maximum leak level limit for a validation to pass may vary geographically, e.g. for urban vs rural regions, or from one country to another where the regulating body (e.g., the FCC in the United States) responsible for deciding acceptable and unacceptable leak levels differs.

Note that while the exemplary process 300 of FIG. 4 was described above with multiple filters each having two available thresholds (the first being narrower and called “preferred” and the second being broader and called “maximum”), variations of process 300 may include and employ any number of recursive loops at each filter, changing whichever filter's limit to become progressively broader or progressively narrower. Regardless of the number of limits which are tested at a given filter and regardless of the ordering of the different limits applied, the objective of a filter is to reduce the total number of QCs which remain from the set 301 as potential candidates to pair with the WO in question. However, it is generally not desirable for a filter to eliminate all candidates except in special circumstances in which the process 300 yields a “fail” validation status without progressing through the entire list of exemplary filters.

It is generally desirable that the same process 207 (e.g., the same process 300) is completed for all unprocessed closed WOs earmarked during this iteration of the scheduled process by which a cable company (or their subsidiary or other applicable agent) manages their repairs and WO docket. In general, a large percentage of closed WOs will be susceptible to being given a pass or else fail value for repair validation by process 300 in accordance with the description above. However, this disclosure also recognizes deviations and special real world scenarios that inevitably occur and accounts. Embodiments may recognize and account for a variety of special circumstances as follows.

Exemplary processes of narrowing down a pool of QC measurement candidates, preferably to a single QC measurement, may make use of various database infrastructure and database processing tools for the application of filters as described above. Process 300 depicts the possibility of applying filters sequentially. Alternatively, some embodiments may apply some filters in an order which differs from the order portrayed by process 300. As still a further available variation, some embodiments may apply/check multiple criteria at the same time. For instance, one or more time criteria and one or more distance criteria may be applied at the same time. Consider the following non-limiting example: Find the closest QC measure to leak location which is less than the preferred distance AND has a positive time delta that is less than preferred time AND has a leakage level less than maximum leak level permitted. If none are found, then check for a negative time delta using the same limits for distance, time, and leak level. If none are found, then expand the distance filter from the preferred distance limit to the maximum distance limit using the same limits for time and leak level. A final logic check if no QC measurements have been found on the previous searches is to expand the time window from the preferred time delta (e.g., <15 mins) to a maximum time delta (e.g., <24 hours). In this scenario, the tech may have forgotten to close the WO on the day he fixed the leakage but remembered to close it on the following day. The time delta in this situation is always negative as a positive value does not apply.

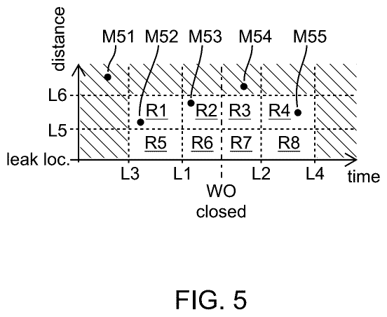

FIG. 5 is a diagram illustrating possible relationships of QC measurements to a particular leak location and WO closure time. A few QC measurements are indicated by points M51, M52, M53, M54, and M55 in the diagram, but it will be appreciated that in any given real world scenario the number and distribution of candidate QC measurements from which one QC measurement is sought to pair with the WO in question will vary.

FIG. 5 portrays leak location as the “0” distance. Each QC measurement (the points M51, M52, M53, M54, and M55) are some distance from the leak location. It is possible a QC measure location is identical to the leak location, in which case such point would fall on the leak location line/axis. Line L1 demarcates the preferred negative time delta. Line L2 demarcates the preferred positive time delta. Line L3 demarcates the maximum negative time delta. Line L4 demarcates the maximum positive time delta. Line L5 demarcates the preferred distance. Line L6 demarcates the maximum distance. See Table III above for explanations of these respective terms.

Any QC measurements which fall in the shaded area of FIG. 5 fail to satisfy the distance filter(s) as well as the time filter(s). Thus QC measurements M51 and M54 are eliminated. In an optimal scenario, there is at least one QC measurement in region R7. A QC measurement in region R7 has a QC measure location which is within the preferred distance limit and a time delta which is positive and within the preferred (positive) time delta limit. If at least one QC measurement occurs in region R7 which has a QC measure frequency (ies) matching the leak frequency (ies) and a QC measure level(s) below the maximum leak level limit, exemplary methods herein would give the WO represented in FIG. 5 a pass status for both repair validation and workmanship validation.

In the absence of a QC measurement in region R7 of FIG. 5 with appropriate frequency and level, exemplary methods may nevertheless identify a QC measurement from one of regions R1, R2, R3, R4, R5, R6, and R8 which the method pairs to the WO and, if such QC measurement passes the frequency and level filters, uses to give the WO a pass status for repair validation. However, according to some exemplary methods, a QC measurement in any of regions R1, R2, R3, R4, R5, R6, and R8 would be interpreted by such methods as cause to record for the WO a fail status for workmanship validation.

At least one reason workmanship validation fails according to a QC measurement in any of regions R1-R4 is because the tech failed to park his vehicle within the preferred distance limit of the leak location. However, despite the distance exceeding the preferred distance limit, it is still within the maximum distance limit, and thus the QC measurement is still close enough to the leak location that the repair may be validated even if the workmanship is not.

At least one reason workmanship validation fails according to a QC measurement in any of regions R1, R2, R5, and R6 is because the tech drove away from the leak location without having first closed the WO (thus QC measurements in regions R1, R2, R5, and R6 like QC measurements M52 and M53 have negative time deltas).

At least one reason workmanship validation fails according to a QC measurement in any of regions R4 and R8 is because the tech lingered too long at the leak location after closing the WO. In general, a tech is expected to move to the next jobsite for his next repair relatively promptly after wrapping up his repair at the present leak location.

Individual administrators and users of exemplary methods herein may ascribe different workmanship validation pass/fail statuses than those explained above for any or all of regions R1-R8. The above described workmanship validation fail explanations are simply one exemplary illustrative implementation in accordance with prevailing expectations of techs in the US cable industry at the time of writing this disclosure.

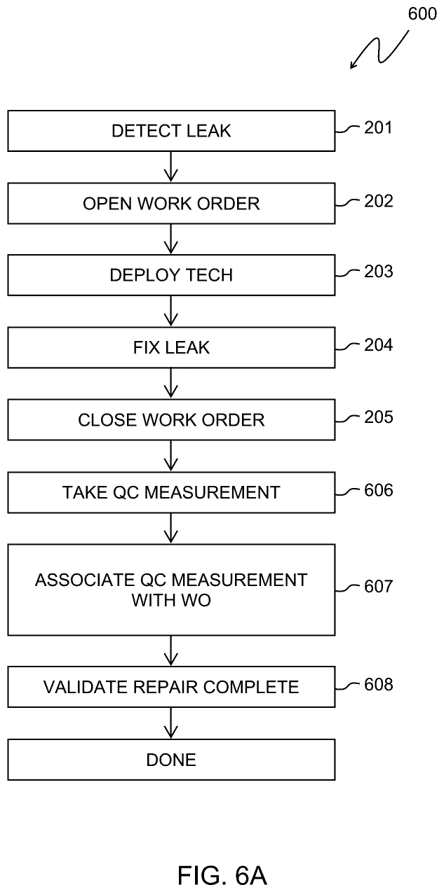

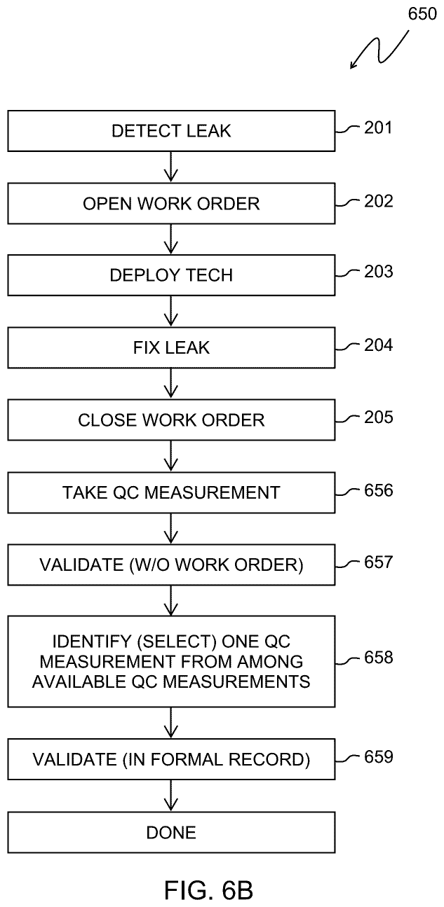

FIG. 6A shows an exemplary process 600 which is similar to process 250 of FIG. 2A with the improvement of introducing a manually assisted or automatically triggered QC measurement. FIG. 6A is useful when, for example, a company has a QC measurement system which operates independently of the WO system such that the two systems do not exchange information in real time. Upon or after the WO being closed at block 205, a QC measurement is recorded at block 606. The recorded QC measurement may include a plurality of variables such as one or more (up to all) of the exemplary QC measurement variables listed in Table I above. At block 607, the recorded QC measurement is associated with the WO by the technician manually entering the QC information into the WO system or by adding the WO information to the QC measurement details. This manual step is required in process 600 as the QC measurement system and the WO system operate independently and do not exchange information in real time. At block 608, the completion of the repair is validated by checking the QC measurement against a set of predefined parameters to determine a pass/fail status.

FIG. 6B shows another exemplary process 650. Upon or after the WO being closed at block 205, a QC measurement is automatically recorded at block 656 and sent to a database for processing at a later time, eliminating the need for the technician to initiate the QC measurement and also eliminating a need to attach the WO details to the QC measurement. The recorded QC measurement may include a plurality of variables such as one or more (up to all) of the exemplary QC measurement variables listed in Table I above.

At block 657, the completion of the repair is validated without association of the QC measurement and the WO in a database. No QC measurement has been associated with the WO at this point in time. The QC measurement taken at block 656 is not assigned to the WO at the time of the WO completion because the automated QC measurement system has no awareness of the WO system since the two systems operate independently. As a post processing step at a later time, at block 658, one (a single) QC measurement is identified (selected) from among many available QC measurements for associating with the WO closed. At block 659, signal information of the leak for which the WO was opened is compared with the signal information of the QC measurement selected at block 658. The comparison reveals whether or not the leak documented in the WO was fixed according to data from actual signal measurement equipment (as opposed to relying on the qualitive word of a technician). If the validation passes, the process is finished. However, if the validation fails, further action (one or more corrective actions) is initiated. For instance, another work order may be opened to address the same leak again.

Exemplary processes discussed above have typically referred to QC measurements and leakage measurements as involving a frequency. It should be appreciated that these examples inherently entail consideration of multiple frequencies which may collectively pertain to a single leak. The standard practice in the US cable TV industry at the time of writing this disclosure is to measure for leakage at multiple frequencies (typically a low, mid, and high frequency) that covers the downstream spectrum used by the operators. Cable leakage can radiate at one, two, or all three frequencies. Every leak is unique in terms of its radiation pattern and its associated resonant frequencies.

Assuming that the leakage detection device can measure all three frequencies simultaneously, a QC measurement may be generated for each of the three frequencies according to some exemplary embodiments. Looking at the example of sample data shown below in Table IV, there are three QC measurements (one for each frequency) taken at approximately the same time each time a QC measurement is triggered. The distances for each of the three measurements could have a slight variance depending on how simultaneous the measurements are taken.

When extracting leakage related data from a closed WO, both the original leak level value(s) and leak frequency(ies) are known. The initial logic used to find the closest matching QC measurement that is associated with a closed WO may be frequency agnostic. In other words, for some embodiments, frequency may not used as a search criteria. Once a matching QC measure has been identified by other filter criteria, e.g. criteria described above in connection with FIG. 4, the frequency information may only then come into play. The closed WO specifies which of the frequencies were initially detected from the leak location. The QC measurement process adds the leakage measurement data to the closed WO for each of the specified frequencies. For example, if the detected leak in the WO listed had two frequency components, the resulting QC measure shows the corresponding leakage measurements for each of the two frequencies.

TABLE IV
Example of three QC measure frequencies per QC event
List of closest QC measurements by Distance
3 frequencies for each QC measurement

| Measurement | Level | Frequency | Distance | Time |
|---|---|---|---|---|
| QC 1 | 6 uV/m | 138 MHz | 57 feet | 1:02 pm |
| QC 2 | 4 uV/m | 612 MHz | 58 feet | 1:02 pm |
| QC 3 | 11 uV/m | 774 MHz | 59 feet | 1:02 pm |
| QC 4 | 6 uV/m | 138 MHz | 143 feet | 2:34 pm |
| QC 5 | 4 uV/m | 612 MHz | 145 feet | 2:34 pm |
| QC 6 | 11 uV/m | 774 MHz | 147 feet | 2:34 pm |

An exemplary process usable to get the additional QC measurement information if there are multiple frequencies involved may including the following steps:
1. The QC measurement with the shortest distance to the leak location is identified using the process(es) outlined in the disclosure above.
2. Because each of the frequency measurements was taken at approximately the same time, the time delta from the chosen QC measurement is used to identify the other two frequency measurements that have approximately the same time as they were triggered by the same QC measurement.
3. The QC measurement values associated with the other frequencies listed on the closed WO are added to the WO.

Example: Using the data shown in Table IV, QC1 is identified as having the shortest distance to the leak: 57 feet. The closed WO indicates that there are two frequencies associated with the detected leak: 138 MHz and 612 MHz. The table of QC measurements is then scanned to find the 138 MHz QC measurement that has the closest timestamp as QC1. QC2 has a frequency of 612 MHz and has the shortest time delta as compared to QC1. They both were taken at 1:02 PM. The QC measurements of 6 μV/m at 138 MHz and 4 μV/m at 612 MHz are then associated with the closed WO.

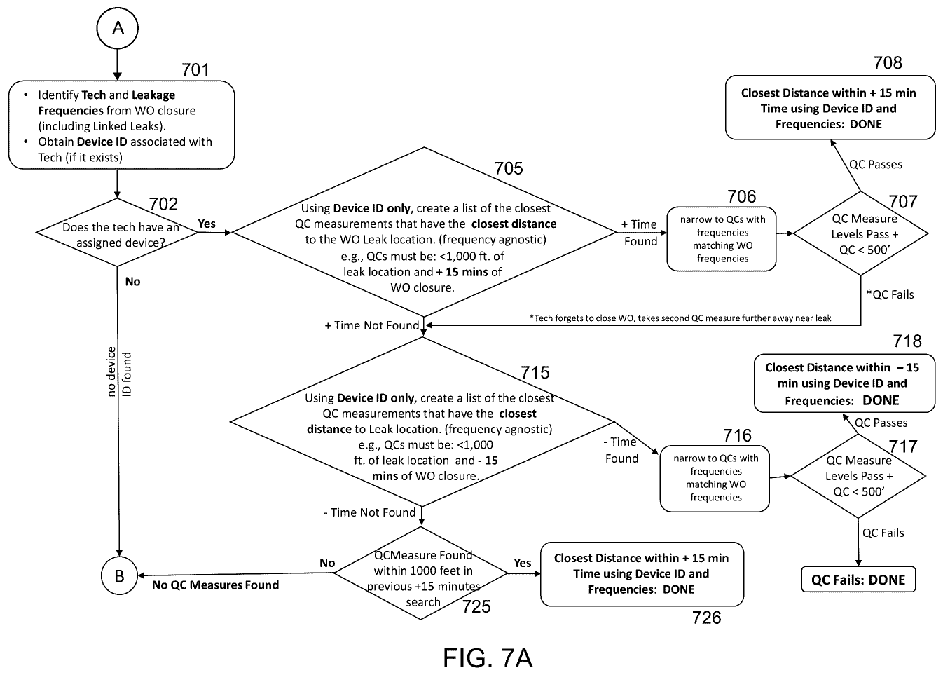

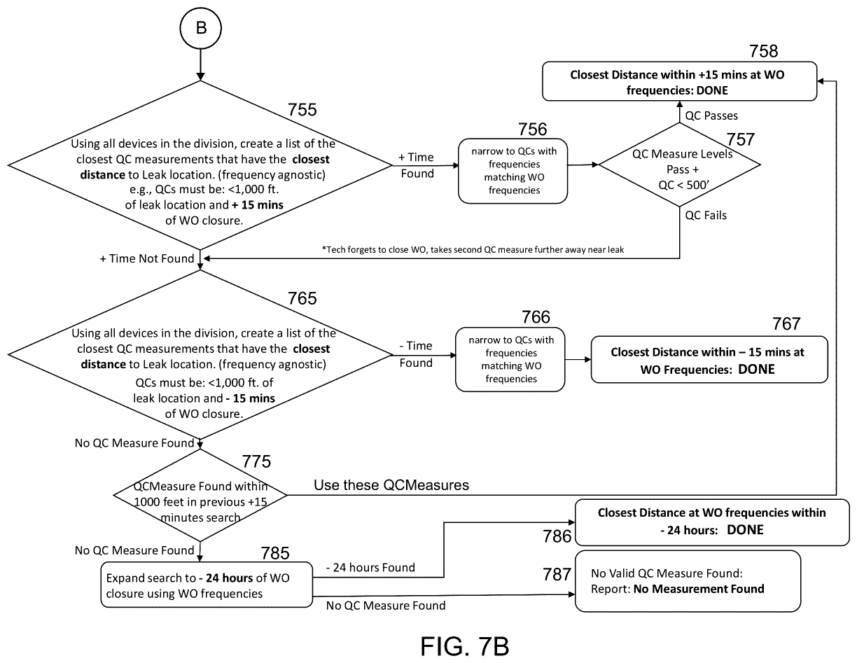

FIGS. 7A and 7B are flowcharts illustrating a further non-limiting example of how a QC measurement may be identified from among many QC measurements for association with a closed WO. FIGS. 7A and 7B are examples of processes which check multiple conditions at the same time while also prioritizing some search/filter conditions over others. FIG. 7A includes the following stages:
ID Check (blocks 701-702): In order to narrow down the possible QC measurements collected by many vehicles over the course of a day, techs' IDs (e.g., names) are used to reference the leakage detection device ID located in their vehicles. This assumes that the device ID has been assigned to a technician which is stored in the remote server database. If no Device ID is associated with the tech, the flowchart immediately proceeds from block 702 to subroutine B of FIG. 7B. When available, however, narrowing down the QC measurements according to their association with a single leakage detection device greatly reduces the pool of QC measurement candidates.
Positive Time Delta Check (blocks 705-708): The pool of candidate QC measurements is reduced to a list of just those QC measurements which have a distance less than a maximum distance limit of, e.g., 1,000 ft. The list is further narrowed by only keeping the QC measurements that have a positive time delta that is less than the maximum time delta of, e.g., 15 mins. Then of the remaining QC measurements, find the QC measurement with the shortest distance and its associated leakage level. If the distance for this QC measurement is less than the preferred distance of, e.g., 500 ft, and the leakage level is below the maximum leak level limit, assign a passing status to the closed WO.
Negative Time Delta Check (blocks 715-718): If no QC measures were found or have a failing status using a positive time delta, create a list of all QC measures that have a distance less than the maximum value (1,000 ft) between the leak location and the QC measure location. Narrow the list further by only keeping QC measurements that have a negative time delta that is less than the maximum time allowed (15 mins). Find the QC measurement with the shortest distance and its associated leakage level. If the distance is less than the preferred distance (500 ft) and the leakage level is below the maximum allowed value, assign a passing status to the closed WO.
Maximum Distance Check (blocks 725-726): If no QC measurements were found with a passing status with either a positive or negative time delta checks, expand the search by looking for QC measures that are within the maximum distance limit (<1,000 ft). Narrow the list further by eliminating QC measurements that have a positive time delta greater than the maximum time allowed (15 mins).

The search to identify a QC measurement to associate with the closed WO continues to FIG. 7B if the criteria described above for FIG. 7A do not produce a valid QC measurement. If there was not a device ID assigned to the technician who closed the work order to start with, then most steps of FIG. 7A are skipped altogether and the process moves forward using FIG. 7B.

If the decision making reaches subprocess B of FIG. 7B, it's because no device ID or QC measurements were found by subprocess A of FIG. 7A. FIG. 7B begins with substantially the same logic for three stages as outlined above in FIG. 7A:
Positive Time Delta Check (blocks 755-758)
Negative Time Delta Check (blocks 765-767)
Maximum Distance Check (blocks 775, 758)
   If the preceding three checks do not yield a QC measurement to associate with the closed WO, then FIG. 7B performs an expanded time search:
Expanded time search (blocks 785-787): A final logic check if no QC measurements have been found on the previous searches is to expand the time window from the preferred time delta (<15 mins) to a maximum time delta (<24 hours). In this scenario, the tech forgot to close the WO on the day they fixed the leakage and remembered to close it on the following day. The time delta is always negative as a positive value does not apply.

The present invention may be or include a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Where a range of values is provided in this disclosure, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described.

As used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely”, “only”, and the like in connection with the recitation of claim elements, or use of a “negative” limitation.

As will be apparent to those of skill in the art upon reading this disclosure, each of the individual embodiments described and illustrated herein has discrete components and features which may be separated from or combined with the features of any of the other several embodiments without departing from the scope or spirit of the present invention. Any recited method can be carried out in the order of events recited or in any other order which is logically possible.

While exemplary embodiments of the present invention have been disclosed herein, one skilled in the art will recognize that various changes and modifications may be made without departing from the scope of the invention as defined by the following claims.

What is claimed is:

1. A method of maintaining cable infrastructure involving a cable signal leak which was detected on a vehicle driveout and for which a work order (WO) was issued for its repair, the method comprising
validating the leak has been repaired based on WO information and a quality control (QC) measurement.

2. The method of claim 1, further comprising initiating corrective action if the validation fails.

3. The method of claim 1, further comprising identifying the QC measurement to be used in the validating step from a single QC measurement.

4. The method of claim 1, wherein the QC measurement was collected by a manual method.

5. The method of claim 1, wherein the QC measurement was collected by an automated method.

6. The method of claim 1, further comprising identifying the QC measurement to be used in the validating step from among a plurality of QC measurements.

7. The method of claim 6, wherein at least some of the plurality of QC measurements are automatically collected by vehicle-based leakage detectors.

8. The method of claim 1, further comprising identifying the QC measurement to be used in the validating step from among a plurality of QC measurements using one or more of: ID information, distance information, time information, and frequency information, wherein ID information is one or more of: technician ID, QC measure vehicle ID, and leakage device ID.

9. The method of claim 1, further comprising narrowing a list of QC measurements down to one QC measurement to be used in the validating step by performing one or more of the following steps:
if a device ID is associated with a technician assigned to the WO, eliminating all QC measurements from the list which do not have a QC measure device ID which matches the device ID associated with the technician,
if the list remains to have more than one QC measurement, eliminating all QC measurements from the list for which an associated QC measure location exceeds a maximum distance from the WO leak location,
if the list remains to have more than one QC measurement and at least one QC measurement remaining in the list has a QC measure time later than a WO closure time by no more than a first time delta, eliminating all QC measurements from the list which do not have a QC measure time later than a WO closure time by no more than a first time delta,
if the list remains to have more than one QC measurement and at least one QC measurement remaining in the list has a QC measure time earlier than a WO closure time by no more than a second time delta, eliminating all QC measurements from the list which do not have a QC measure time earlier than a WO closure time by no more than a second time delta, and
eliminating all QC measurements from the list which do not have a QC measure frequency which matches a leak frequency in the WO information.

10. The method of claim 1, further comprising
determining whether a leakage detection device ID exists for a technician identified in the WO information as having closed the WO,
wherein if the leakage detection device ID exists, the identifying step eliminates from selection any of the plurality of QC measurements which are not associated with the leakage detection device ID.

11. The method of claim 1, further comprising
comparing a WO leak location given in the WO information with QC locations of respective ones of a plurality of QC measurements,
identifying the QC measurement to be used in the validating step from among the plurality of QC measurements wherein the step of identifying excludes from selection any of the plurality of QC measurements for which a difference in distance in the step of comparing exceeds a predetermined threshold.

12. The method of claim 1, further comprising
comparing a WO closure time with QC measurement times at which respective ones of a plurality of QC measurements were taken; and
identifying the QC measurement to be used in the validating step from among the plurality of QC measurements based on at least the step of comparing.

13. The method of claim 1, further comprising
comparing one or more WO leak frequencies given in the WO information with one or more QC frequencies of respective ones of a plurality of QC measurements; and
identifying the QC measurement to be used in the validating step from among the plurality of QC measurements based on at least the step of comparing.

14. The method of claim 1, wherein the QC measurement is automatically collected by a vehicle-based leakage detector, wherein the vehicle-based leakage detector automatically collects the QC measurement based on one or more triggers including a vehicle equipped with the vehicle-based leakage detector remaining stationary for at least a predetermined amount of time.

15. A system for maintaining cable infrastructure involving a cable signal leak which was detected on a vehicle driveout and for which a work order (WO) was issued for its repair, the system comprising one or more processors configured to perform
validating the leak has been repaired based on WO information and a quality control (QC) measurement.

16. The system of claim 15, wherein the one or more processor are further configured to perform
identifying the QC measurement to be used in the validating step from a plurality of QC measurements or from a single QC measurement.

17. The system of claim 15, wherein the one or more processor are further configured to perform narrowing a list of QC measurements down to one QC measurement to be used in the validating step by performing one or more of the following steps:
if a device ID is associated with a technician assigned to the WO, eliminating all QC measurements from the list which do not have a QC measure device ID which matches the device ID associated with the technician,
if the list remains to have more than one QC measurement, eliminating all QC measurements from the list for which an associated QC measure location exceeds a maximum distance from the WO leak location,
if the list remains to have more than one QC measurement and at least one QC measurement remaining in the list has a QC measure time later than a WO closure time by no more than a first time delta, eliminating all QC measurements from the list which do not have a QC measure time later than a WO closure time by no more than a first time delta,
if the list remains to have more than one QC measurement and at least one QC measurement remaining in the list has a QC measure time earlier than a WO closure time by no more than a second time delta, eliminating all QC measurements from the list which do not have a QC measure time earlier than a WO closure time by no more than a second time delta, and
eliminating all QC measurements from the list which do not have a QC measure frequency which matches a leak frequency in the WO information.

18. The system of claim 15, wherein the one or more processors comprise
at least a first processor belonging to a QC measurement system, and
at least a second processor belonging to a WO system.

19. The system of claim 18, wherein the QC measurement system and the WO system do not exchange information in real time.

20. The system of claim 18, wherein the QC measurement system and the WO system exchange information in real time.
